(19) United States
(12) Patent Application Publication
(10) Pub. No.: US 2010/0273964 A1
(43) Pub. Date: Oct. 28, 2010

(54) HETEROGENEOUS LEWIS ACID CATALYSTS FOR CATIONIC POLYMERIZATIONS

(76) Inventor: Stewart Lewis, Blacksburg, VA (US)

Correspondence Address: RENNER KENNER GREIVE BOBAK TAYLOR & WEBER, FIRST NATIONAL TOWER, SUITE 400, 106 SOUTH MAIN STREET, AKRON, OH, 44308-1412, US

(21) Appl. No.: 12/428,099

(22) Filed: Apr. 22, 2009

(51) Int. Cl. C08F 4/52

(52) U.S. Cl. 526/189; 502/118

(57) ABSTRACT

A process for cationically polymerizing olefin monomers in a reaction mixture includes the step of contacting olefin monomers and a catalytically effective amount of an initiating composition containing (A) a heterogeneous Lewis acid coinitiator selected from the group consisting of open chain and cyclic aluminoxane compounds and (B) an initiator selected from the group consisting of (i) organic compounds, (ii) halogens, (iii) interhalogens; (iv) Brönsted acids, (v) boron halides; and (vi) silicon compounds. A novel initiator system is further disclosed.

### TECHNICAL FIELD

Generally, the present invention relates to initiator systems and their application in cationic polymerization of olefin monomers. More particularly, the present invention relates to initiator systems containing heterogeneous Lewis acid coinitiators that are amenable to multiple batch and/or continuous polymerization processes.

### BACKGROUND OF THE INVENTION

Cationic polymerization is used in the preparation of a number of commercially important polymers (e.g. butyl rubber, polyisobutylene {PIB}). Current polymerization systems have many shortcomings. First, they require low temperatures for the suppression of chain transfer/termination events to allow for the production of high molecular weight products. Such polymerizations are energy intensive; temperatures as low as −100° C. are required in the synthesis of high molecular weight grades of butyl rubber and PIB. This contributes significantly to overall cost. Second, many traditional initiator systems, such as aluminum trichloride, only operate effectively in chlorinated solvents. The use of such solvents (e.g. methyl chloride) is becoming ever more costly and regulated due to legislation designed to protect the environment (e.g. Kyoto Protocol). Third, given their homogeneous character, conventional initiator systems do not lend themselves to continual polymerization processes. This lowers productivity and increases overall material consumption and waste generation as components of the initiator system remain in the product stream necessitating costly de-ashing steps that preclude their reuse. Fourth, most commercial processes rely solely on temperature as a means of effecting control over polymer molecular weight. Due to the exothermic nature of polymerization, this can make targeting a specific molecular weight difficult as there are no other process parameters that control molecular weight. Fifth, many current initiator systems give rise to low levels of exo-olefinic (terminal vinylidene) chain-end functionalities. Such functionalities are desirable as they readily participate in post-polymerization functionalization reactions; thus, higher levels are needed. Sixth, some systems do not give rise to satisfactory yields of polymer on a useful time scale. For example, in one report, copolymerizations of isobutylene and isoprene initiated by a system based on triethylchlorosilane and lithium tetrakis(pentafluorophenyl)borane took 3 hours to reach only about 30 percent conversion. Consequently, such systems may not be commercially viable or cost effective. Seventh, many initiator systems rely on costly components (e.g. perfluoroarylated compounds) that prohibit their usage on an industrial scale.

While numerous initiator systems have been researched and developed for the preparation of high molecular weight polymers (such as, for example and in particular, butyl rubber and PIB) at elevated reaction temperatures under cationic conditions, none of these initiator systems address all, or even most, of the aforementioned deficiencies inherent in cationic polymerization. More particularly, no initiator system (other than, perhaps, gamma radiation) has been known to produce polymers higher in molecular weight than the present invention using the cationic polymerization of olefin monomers, in bulk, suspension solution or the gas phase, at elevated reaction temperatures (i.e. those temperatures above about −100° C.) without requiring the use of chlorinated solvents. Deleting the use of such chlorinated solvents will undoubtedly result in providing substantial saving in terms of both monetary costs as well as energy, and will reduce the impact on the use of such deleterious compounds on the environment.

Thus, there exists a need to provide a initiating system at a low cost that is capable of producing a polymer from one or more olefin monomers with a molecular weight at least equal to and, in most cases, exceeding that which can be obtained from a conventional initiator system at a given temperature in the absence of chlorinated solvents. Conventional initiator systems are well known in the art and are discussed and set forth in Kennedy, J. P.; Squires, R. G. Polymer, 1965, 6, 579-587, the disclosure of which is incorporated herein by reference. There is further a need to provide an initiating system in a form that is conducive to multiple batch and/or continuous polymerization processes and can be readily isolated from the reaction medium or products in order to minimize product purification steps and to minimize waste while maximizing economic and environmental benefits. Furthermore, in the cationic polymerization of these polymers, using an initiator system at an elevated temperature and without chlorinated solvents, a need also arises for a method by which to control the polymer microstructure (e.g. molecular weight, chain-end functionality) while also addressing the shortcomings present in previous cationic polymerization systems.

### SUMMARY OF THE INVENTION

Any one or more of the foregoing aspects of the present invention, together with the advantages thereof over known art relating to initiator systems which will become apparent from the specification that follows, may be accomplished by the invention as hereinafter described and claimed.

The present invention provides a process for cationically polymerizing olefin monomers in a reaction mixture. The process comprises the step of contacting olefin monomers and a catalytically effective amount of an initiating composition containing (A) a heterogeneous Lewis acid coinitiator selected from the group consisting of open chain and cyclic aluminoxane compounds of the formulas (I) and (II)

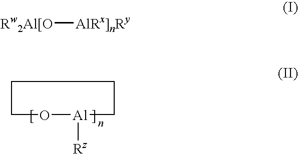

wherein R^{w}, R^{x}, R^{y}, and R^{z} are the same or different and are selected from the group consisting of a C₁-C₁₀ alkyl or a halide, and n is an integer from 2 to 30; wherein the heterogeneous Lewis acid coinitiator is essentially insoluble in the reaction mixture and is either supported on an inert substrate containing reactive functionalities selected from the group consisting of —OH, —SH, and —NH₂, that can chemically bind to the aluminoxane compounds or unsupported by any inert substrate; and (B) an initiator compound selected from the group consisting of (i) organic compounds having the formula (III):

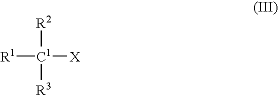

wherein X is selected from the group consisting of halogens, N₃, CN, and CF₃SO₃; R¹, R², and R³ are selected from the group consisting of a hydrogen atom, halogens, N₃, CN, CF₃SO₃, SiR₃⁴, OSiR₃⁴, C₁-C₁₀ alkyl, C₃-C₁₀ cycloalkyl, C₆-C₁₈ aryl, combinations thereof, and derivatives thereof containing substituents thereof; R⁴ is selected from the group consisting of a hydrogen atom, halogens, N₃, CN, CF₃SO₃, C₁-C₁₀ alkyl, C₃-C₁₀ cycloalkyl, C₆-C₁₈ aryl, combinations thereof, and derivatives thereof containing substituents thereof; and C¹ is a carbon atom; (ii) halogens; (iii) interhalogens; (iv) Brönsted acids, (v) boron halides; and (vi) silicon compounds having the formula (IV):

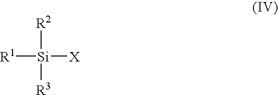

wherein X is selected from the group consisting of halogens, N₃, CN, CF₃SO₃, SiR₃⁴, and OSiR₃⁴; R¹, R², R³ and R⁴ is selected from the group consisting of a hydrogen atom, X, C₁-C₁₀ alkyl, C₃-C₁₀ cycloalkyl, C₆-C₁₈ aryl, combinations thereof and derivatives thereof containing substituents thereof; with the proviso that where the Lewis acid coinitiator is unsupported, then the initiator is selected from the initiator compounds other than the organic compounds of formula (III), under cationic polymerization reaction conditions.

The present invention also provides an initiator system for use with a reaction mixture in the cationic polymerization of olefins, the initiator system comprising:
(a) a hetergeneous Lewis acid coinitiator selected from the group consisting of open chain and cyclic aluminoxane compounds of the formula (I) and (II)

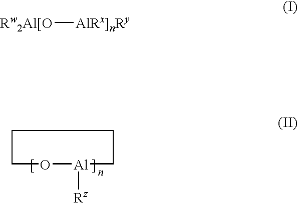

wherein R^{w}, R^{x}, R^{y}, and R^{z} are the same or different and are C₁-C₁₀ alkyls or halides, and n is an integer from 2 to 30, and wherein the heterogeneous Lewis acid coinitiator is essentially insoluble in the reaction mixture and is either supported on a inert substrate containing reactive functionalities selected from the group consisting of —OH, —SH, and —NH₂, that can chemically bind to the aluminoxane compounds or unsupported by any inert substrate; and
(b) an initiator selected from the group consisting of (i) organic compounds having the formula (III):

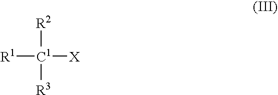

wherein X is selected from the group consisting of halogens, N₃, CN, and CF₃SO₃; and R¹, R², and R³ is selected from the group consisting of a hydrogen atom, halogens, N₃, CN, CF₃SO₃, SiR₃⁴, OSiR₃⁴, C₁-C₁₀ alkyl, C₃-C₁₀ cycloalkyl, C₆-C₁₈ aryl, combinations thereof, and derivatives thereof containing substituents thereof; and R⁴ is selected from the group consisting of a hydrogen atom, halogens, N₃, CN, CF₃SO₃, C₁-C₁₀ alkyl, C₃-C₁₀ cycloalkyl, C₆-C₁₈ aryl, combinations thereof, and derivatives thereof containing substituents thereof; and C¹ is a carbon atom; (ii) halogens; (iii) interhalogens; (iv) Bronsted acids, (v) boron halides; and (vi) silicon compounds having the formula (IV):

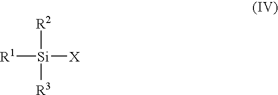

wherein X is selected from the group consisting of halogens, N₃, CN, CF₃SO₃, SiR₃⁴, and OSiR₃⁴; R¹, R², R³ and R⁴ is selected from the group consisting of a hydrogen atom, X, C₁-C₁₀ alkyl, C₃-C₁₀ cycloalkyl, C₆-C₁₈ aryl, combinations thereof and derivatives thereof containing substituents thereof; with the proviso that where the Lewis acid coinitiator is unsupported, then the initiator is selected from the compounds other than the (i) organic compounds of formula (III).

Beneficially, the above initiator system can be used in the polymerization of olefin monomers without any requisite use of objectionable chlorinated solvents, and can be used at elevated temperatures well above those traditional temperatures used for polymerization in chlorinated solvents. The heterogeneous Lewis acid coinitiators of the initiator system of the present invention are amenable to multiple batch or continuous polymerization processes, are readily isolated from the reaction medium via filtration, and do not contaminate the reaction medium or product with free Lewis acids. Thus, waste is reduced, providing further cost and environmental benefits.

### DETAILED DESCRIPTION OF ONE OR MORE EMBODIMENTS

In the present invention, the use of novel initiator systems containing heterogeneous Lewis acids (supported and unsupported) has been developed in the cationic polymerization of olefins. Unlike previously described systems, the process of the current invention readily gives rise to higher yields of high molecular weight polymer, i.e., those polymers having a molecular weight of at least 100,000 g/mol, than previously employed polymerization processes, particularly those that used chlorinated solvents. Further, the process of the present invention can be conducted at reaction temperatures equal to or in excess of the temperatures that would have to be employed by other polymerization processes, including those that employ chlorinated solvents. In at least one embodiment, the present invention is devoid of any chlorinated solvents. In other words, the polymerization process of the present invention provides for the production of higher molecular weight polymers on a useful timescale, made from olefin monomers and a unique initiator system, at elevated temperatures compared to temperatures employed by other similar processes, those similar processes requiring the use of chlorinated solvents. In comparison to existing systems, the process of the present invention is superior in that it can be used in continual polymerization processes, is readily isolable, and, by itself, does not contaminate the polymer product with free Lewis acid.

Further, it has been discovered that the supported heterogeneous Lewis acids display enhanced activity for cationic polymerization of olefins (especially at elevated polymerization temperatures) compared to non-supported heterogeneous Lewis acids. As a result, a lower overall concentration of Lewis acid is required for polymerizations using supported heterogeneous Lewis acids resulting in additional cost savings.

In at least one embodiment of the present invention, a process for cationically polymerizing olefin monomers in a reaction mixture is provided. The process comprises the step of contacting olefin monomers and a catalytically effective amount of an initiating composition. Suitable, non-limiting examples of olefin monomers suitable for use in the present invention include, but are not necessarily limited to, propylene, 1-butene, isobutylene, 2-methyl-1-butene, butadiene, isoprene, piperylene, 2,3-dimethylbutadiene, 2,4-dimethyl-1,3-pentadiene, cyclopentadiene, methylcyclopentadiene, limonene, myrcene, 1,3-cyclohexadiene, alpha and beta pinene, alpha-methyl styrene, styrene, p-methyl styrene, vinyl-toluene (and its isomers), divinylbenzene, indene, coumarone, methyl vinyl ether, ethyl vinyl ether, and isobutyl vinyl ether. The initiating composition may contain one of two general classes or embodiments of initiator systems, each initiator system comprising a heterogeneous Lewis acid coinitiator and an initiator compound. In one embodiment the Lewis acid is chemically bound to an inert support; in the other embodiment, the Lewis acid is unsupported.

In one of the two embodiments according to the concepts of the present invention, a heterogeneous Lewis acid coinitiator may include an open chain aluminoxane compound, a cyclic aluminoxane compound, or combinations thereof. Aluminoxanes (or alumoxanes) are oligomeric aluminum-oxy compounds containing alternating aluminum and oxygen atoms where aluminum is typically substituted with an alkyl group. Aluminoxanes are believed to exist in both linear and cyclic forms, corresponding to formulas (I) and (II), respectively

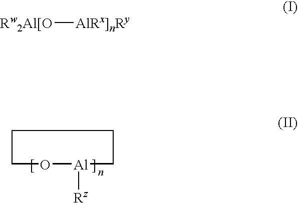

wherein R^{w}, R^{x}, R^{y}, and R^{z} are the same or different and is a C₁-C₁₀ alkyl (e.g. methyl, ethyl, propyl, butyl, iso-butyl) or a halide, and n is an integer from 2 to 30. In addition, the heterogeneous Lewis acid coinitiator is essentially insoluble in the reaction mixture, and is chemically bound to an inert support (i.e. supported heterogeneous Lewis acid coinitiator). In one embodiment each R is a methyl group. In another embodiment, the Lewis acid coinitiator is methyl aluminoxane. In another embodiment, n is greater than 4.

For the purposes of this invention, the term ‘inert support’ refers to either inorganic or organic substrates containing reactive functionalities (e.g. —OH, —SH, —NH₂) that can form chemical bonds to select Lewis acidic compounds (i.e. aluminoxanes) to produce a heterogeneous Lewis acid capable of inducing cationic polymerization in conjunction with an appropriate initiator.

The inert support itself is incapable of inducing polymerization but instead enhances the activity of the supported Lewis acidic compound(s) that are bound to it. The inert support immobilizes the Lewis Acid compounds(s) in such a manner that Lewis acidic species do not substantially leach into the reaction medium or reaction products. Thus, for purposes of the present invention, the phrase “essentially insoluble” means that the Lewis acid does not substantially dissolve or leach into the reaction medium or the reaction products, in contrast to soluble Lewis acids. Because they are essentially insoluble, the resultant heterogeneous Lewis acids can be used in multiple batch and continuous reaction processes and are recovered readily by simple filtration techniques.

As noted above, the inert support may be an inert inorganic support or an inert organic support. The term ‘inert inorganic support’ refers to inorganic oxide substrates (incapable of inducing polymerization alone) containing free hydroxyl groups that can react with select Lewis acidic compounds to form a heterogeneous Lewis acid coinitiator capable of inducing polymerization in conjunction with an appropriate initiator. They may include single and complex inorganic oxides, metal hydroxides, and hydrated metal halides. Non-limiting examples of inert inorganic supports include silica, alumina, titania, magnesia, zirconia, zinc oxide, iron oxides, barium oxide, chromium oxides, manganese dioxide, silica-alumina, silica-titania, silica-magnesia, silica-alumina-zirconia, silica-alumina-thoria, crystalline aluminosilicates (e.g. synthetic {A, X, ZSM-5} and natural {faujasite, mordenite} zeolites; mesoporous molecular sieves {e.g. MCM-41}), open lattice clays (e.g. bentonite, montmorillonite), metal hydroxides (e.g. zirconium hydroxide, indium hydroxide, boric acid), hydrated magnesium chloride, and metal oxide gels or gel oxides (e.g. silica gel, silica-alumina gel).

The term ‘inert organic support’ refers to both naturally occurring and synthetic polymeric substrates (incapable of inducing polymerization alone) with reactive functionalities (e.g. —OH, —SH, —NH₂) that can form chemical bonds to select Lewis acidic compounds (i.e. aluminoxane compounds) to form a heterogeneous Lewis acid coinitiator capable of inducing polymerization in conjunction with an appropriate initiator. Non-limiting examples of inert organic supports include polysaccharides (e.g. starches, cellulosic polymers {i.e. cotton}), phenolic resins (e.g. phenol-aldehyde), amino resins (e.g. urea-aldehyde), ion-exchange resins (e.g. amino, hydroxyl, and thiol functionalized divinylbenzene crosslinked polystyrenes), poly(allylamine), poly(4-vinyl phenol), poly(vinyl alcohol), and polyethyleneimine.

For the purposes of this invention, aluminoxane may be chemically bound to the inert support using a number of previously described approaches, many which are summarized in Chem. Rev. 2005, 105, 4073-4147, and are incorporated herein by reference. For example, as described in U.S. Pat. No. 6,043,180 and related documents calcined silica may be treated at room temperature with a hydrocarbon solution of methylaluminoxane (MAO), reduced to a solid and heated under vacuo, washed with hydrocarbon and then dried under vacuo to yield silica supported MAO. Another useful strategy, as detailed in U.S. Pat. No. 5,629,253 and is incorporated herein by reference, involves reaction of an alkylaluminum compound (e.g. trimethylaluminum) with a water impregnated (undehydrated) support material to produce a supported aluminoxane. Yet another useful method entails a slight modification of procedures disclosed in U.S. Pat. No. 6,136,742 and Macromol. Rapid Commun. 1998, 19, 505, both incorporated herein by reference. This modification involves pore filling an inorganic supported aluminoxane (e.g. silica supported MAO) with an organic monomer capable of undergoing crosslinking reactions (e.g. divinyl benzene) and then subjecting the resultant mixture to conditions conducive for either free radical (e.g. benzoyl peroxide/heat) or cationic (e.g. cumyl chloride) polymerization to yield an inorganic supported aluminoxane encapsulated in a crosslinked organic polymer.

The weight percent of aluminoxane relative to the total combined weight of aluminoxane and support is dependent upon the identity of the support itself and may range from 1 wt % up to the threshold value for the support in question; above which, the support is saturated and cannot chemically bind additional aluminoxane. Typically, the weight percent of aluminoxane for such heterogeneous Lewis acids will range from 1-20 wt %.

In addition to the heterogeneous Lewis acid coinitiator, the initiator system also includes an initiator compound. There are a number of classes of initiator compounds that can be used. These classes of compounds include organic compounds represented by the formula (III) hereinbelow, halogens, interhalogens, Bronsted acids, boron halides, and silicon compounds represented by the formula (IV) hereinbelow.

In one embodiment, a class of initiator compounds that can be utilized are the organic compounds represented by the formula (III)

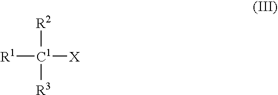

wherein X may include at least one of the following: a halogen, N₃, and CF₃SO₃; and R¹, R², and R³ are the same or different and are selected from the group consisting of a hydrogen atom, halogens, N₃, CN, CF₃SO₃, SiR₃⁴, OSiR₃⁴, C₁-C₁₀ alkyl, C₃-C₁₀ cycloalkyl, C₆-C₁₈ aryl, combinations thereof, and derivatives thereof containing substituents thereof. Alternatively R₁ and R₂ or R₁, R₂, and R₃ may be combined together so that they represent a single substituent (e.g. ring) in which C¹ is a member. For SiR₃⁴ and OSiR₃⁴, R⁴ may be selected from the group consisting of a hydrogen atom, halogens, N₃, CN, CF₃SO₃, C₁-C₁₀ alkyl, C₃-C₁₀ cycloalkyl, C₆-C₁₈ aryl, combinations thereof, and derivatives thereof containing substituents thereof. C¹ is a carbon atom. Non-limiting examples of compounds that would be included in this class of compounds are 2-chloro-2,4,4-trimethylpentane (TMPCI), t-butyl chloride, neopentyl chloride, 2-chloropropane, and chloromethane.

In another embodiment, the initiator compound may include halogens. Suitable halogen compounds may include F₂, Cl₂, Br₂, or I₂. In another embodiment the initiator compound may include interhalogens, such as ClF, BrCl, ICl, or IBr. Further, in other embodiments, Bronsted acids may be employed as the initiator compound. Suitable Bronsted acids include but are not limited to: HCl, HBr, HI, H₂SO₄, FSO₃H, CF₃SO₃H, or HClO₄. In still other embodiments, a boron halide may be employed. Suitable boron halides include but are not limited to: BBr₃, BCl₃, or BF₃.

In yet another embodiment, silicon compounds can be employed as the initiator compound within the initiator system. For purposes of this invention, the term “silicon compound” refers to any silicon compound containing at least one silicon-carbon bond, silicon-hydrogen bond, or sililcon-oxygen, but for at least one embodiment, the silicon compounds are limited to those silicon compounds represented by the formula (IV),

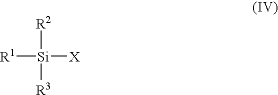

wherein X is selected from the group consisting of halogens, N₃, CN, CF₃SO₃, SiR₃⁴, and OSiR₃⁴ and R¹, R², R³ and R⁴ may be the same or different and selected from the group consisting of a hydrogen atom, X (except R⁴), C₁-C₁₀ alkyl, C₃-C₁₀ cycloalkyl, C₆-C₁₈ aryl, combinations thereof and derivatives thereof containing substituents thereof. Alternatively R₁ and R₂ or R₁, R₂, and R₃ may be combined together so that they represent a single substituent (e.g. ring) in which Si is a member. It will be appreciated that formula (IV) parallels and is essentially the same formula as formula (III), but that Si has been substituted for C¹. Suitable silicon compounds falling into this class of compounds would include the following examples: chlorotrimethylsilane, phenyldimethylchlorosilane, dichlorodimethylsilane.

In the second of the two embodiments according to the concepts of the present invention, the heterogeneous Lewis acid coinitiator comprises an open chain aluminoxane compound, a cyclic aluminoxane compound, or combinations thereof, corresponding to formulas (I) or (II) above, but that are not chemically bound to an inert support. These compounds, nevertheless, possess low to no solubility in the polymerization reaction mixture or products (i.e. unsupported heterogeneous Lewis acid coinitiator), and are, therefore, still essentially insoluble in the polymerization reaction mixture.

The initiator system of this embodiment also includes an initiator compound. The initiator compounds for use with these unsupported Lewis acid so-initiators are essentially the same as provided above for the supported Lewis acid coinitiators, with the proviso that no initiator compounds may include the organic compounds of formula (III) described above. However, halogens, interhalogens, Bronsted acids, boron halides, and silicon compounds represented by the formula (IV) above are all suitable classes of initiator compounds for this second embodiment. In one embodiment, the initiator system includes (A) an unsupported Lewis acid coinitiator corresponding to one of formulas (I) or (II),

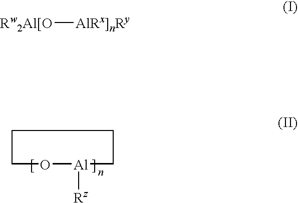

wherein R^{w}, R^{x}, R^{y}, and R^{z} are the same or different and is a C₁-C₁₀ alkyl (e.g. methyl, ethyl, propyl, butyl, iso-butyl) or a halide, and n is an integer from 2 to 30, and (B) a silicon compound represented by the formula (IV):

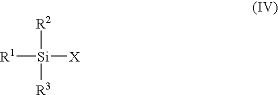

and wherein X is selected from the group consisting of halogens, N₃, CN, CF₃SO₃, SiR₃⁴, and OSiR₃⁴ and R¹, R², R³ and R⁴ may be the same or different and selected from the group consisting of a hydrogen atom, X, C₁-C₁₀ alkyl, C₃-C₁₀ cycloalkyl, C₆-C₁₈ aryl, combinations thereof and derivatives thereof containing substituents thereof. Alternatively R₁ and R₂ or R₁, R₂, and R₃ may be combined together so that they represent a single substituent (e.g. ring) in which Si is a member.

In one embodiment according to the concepts of the present invention, the novel initiating systems are useful in the homo- and copolymerization of olefin monomers possessing at least one ethylenically unsaturated group capable of undergoing cationic polymerization. In one embodiment, the polymerization of the various useful olefin monomers noted above may be represented by the non-limiting generic structural formula (V)

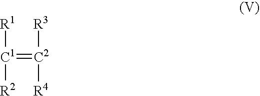

where X may include at least one of the following: halogen, OR⁵, O, N, SiR₃⁵, and OSiR₃⁵, wherein each R may be the same or different and each of R¹, R², R³, R⁴ and R⁵ may be a hydrogen atom, X (except R⁵), or any of the following (optionally substituted by X) but not limited to: C_{1-C}₁₀ alkyl, C₃-C₁₀ cycloalkyl, C₆-C₁₈ aryl, C₂-C₈ alkenyl, or C₂-C₁₀ alkyne. Alternatively R¹ and R², R³ and R⁴, R¹ and R³, R² and R⁴, may be combined together so that they represent a single substituent (e.g. ring) in which C¹ and/or C² are members.

Again, suitable olefin monomers include but are not limited to: propylene, 1-butene, isobutylene, 2-methyl-1-butene, butadiene, isoprene, piperylene, 2,3-dimethylbutadiene, 2,4-dimethyl-1,3-pentadiene, cyclopentadiene, methylcyclopentadiene, limonene, myrcene, 1,3-cyclohexadiene, alpha and beta pinene, alpha-methyl styrene, styrene, p-methyl styrene, vinyl-toluene (and its isomers), divinylbenzene, indene, coumarone, methyl vinyl ether, ethyl vinyl ether, and isobutyl vinyl ether.

Polymerization may be performed in bulk, solution, suspension or in the gas phase and may be conducted in multiple or single stages. Any number of reactor geometries or types may be used including but not limited to: batch, stirred tank, fluidized bed, continuous tank, and tubular. Polymerization reaction temperatures can range from −100° C. to 200° C. and pressures can range from 0.1 bar to 1000 bar. In one embodiment, the polymerization reaction temperature is greater than −80° C. In another embodiment, the polymerization reaction temperature is greater than −40° C. In another embodiment, the polymerization reaction temperature is greater than −20° C. In another embodiment, the polymerization reaction temperature is greater than 0° C. And in another embodiment, the polymerization reaction temperature is room temperature.

Monomer concentration may range from 1-100 vol % relative to the total volume of the polymerization reaction mixture depending upon the desired process conditions. In copolymerizations, the concentration of comonomer(s) can vary in any manner so as to give rise to a copolymer with desired physical properties. A “catalytically effective amount” of an initiating composition may be determined empirically by adjusting the concentration of both the initiator and the coinitiator with respect to monomer to the point that polymerization ceases to occur. When the concentrations of initiator and coinitiator are above such levels, they are deemed to be present in a catalytically effective amount. In the case of isobutylene, it has been found that 1 part by weight initiator in conjunction with 20 parts by weight unsupported coinitiator are well above what is considered to be a catalytically effective amount for the polymerization of 2,000 parts by weight monomer.

Depending on the process conditions, polymerizations involving initiator systems as described in the first embodiment of the present invention (i.e. supported aluminoxane) may be conducted in solvents or diluents that typically dissolve aluminoxane whereas those that make use of initiator system of the second embodiment (i.e. unsupported aluminoxane) should be conducted in solvents or diluents that are non-solvents for aluminoxane. A non-limiting list of suitable solvents/diluents includes nitromethane, methyl chloride, chloroform, toluene, hexane, heptane, cyclohexane, and isopentane.

In the process according to the invention, the heterogeneous Lewis acid component is used in a molar ratio relative to the initiator component (mol heterogeneous Lewis acid:mol initiator) of 1:100 to 10,000:1, In one embodiment, the range is from about 1:10 to about 100:1. In another embodiment, the range is from about 1:1 to about 10:1. The initiator component concentration may range from about 1 M to about 10⁻⁷ M and is dependent upon the desired molecular weight of the polymer product.

In order to demonstrate the practice of the present invention, the following examples have been prepared and tested. The examples should not, however, be viewed as limiting the scope of the invention. The claims will serve to define the invention.

### EXAMPLES

### Materials

Unless indicated otherwise all reagents were obtained from commercial sources and used without further treatment. Polymerizations were conducted in glassware that had been previously passivated by treatment with chlorotrimethylsilane. Isobutylene polymerizations were conducted in 3 oz pressure reaction bottles (Andrew's Glass Co.) and styrene polymerizations were conducted in test tubes. Isobutylene (CP grade) was used without further purification. Uninhibited styrene was obtained by washing 3 times with 10 wt % NaOH (aq) followed by 4 times with deionized water and was dried by storage over CaCl₂. Chlorotrimethylsilane was distilled under nitrogen and subjected to 3 freeze/pump/thaw cycles prior to use. Hexanes were distilled from sodium under nitrogen, subjected to 3 freeze/pump/thaw cycles and stored over a mixture of activated 3 Å molecular sieves and alumina. Benzene was distilled from potassium under nitrogen, subjected to 3 freeze/pump/thaw cycles and stored-over a mixture of activated 3 Å molecular sieves and alumina. 1,4-Di-(1-chloro-1-methyl ethyl)benzene(dicumyl chloride {DiCCl}) was made according to an existing literature procedure by hydrochlorination of α,α,α′,α′-tetramethyl-1,4-benzene-dimethanol.

### Instrumentation

Molecular weight determination was conducted by size exclusion chromatography (SEC) and by static light scattering. Instrumentation consisted of a Wyatt MiniDawn light scattering detector (calibrated by the Rayliegh ratio for toluene), a Wyatt ViscoStar viscometer, and a Waters 410 differential refractometer. The columns (3 MZ SDplus, 5 μm linear, 300×8 mm) were eluted with THF (1.0 mL/min 35° C). Sample concentration was 10-15 mg/mL and the reported dn/dc value (0.11) for polyisobutylene was used in calculations.

### EXAMPLE 1

### Synthesis of Silica Supported Methylaluminoxane 10 wt %

Grace Davison 28-200 mesh Grade 11 silica gel was dried under dynamic vacuum at 250° C. for 3 hours prior to use. A Schlenk flask was charged with 27.0 g dried silica gel and 3.0 g solid MAO. The flask was then cooled to 0° C. and 150 mL of benzene were cannulated into the flask under nitrogen to produce a slurry. This mixture was then stirred for 16 hours at room temperature after which volatiles were removed under reduced pressure to produce a white solid. This solid was then heated to 175° C. for 2 hours under dynamic vacuum. The solid was then cooled to room temperature and 125 mL of benzene were cannulated into the flask under nitrogen to produce a slurry. The slurry was heated to 70° C. under nitrogen, stirred for 1 hour, filtered, and then dried under reduced pressure at 70° C. for 2 hours.

Isobutylene Polymerization using Silica Supported Methylaluminoxane 10 wt % in Conjunction with Organosilicon Compounds (Runs 1-5)

A 3 oz pressure reaction bottle was charged with 0.500 g 10 wt % silica supported methylaluminoxane under nitrogen, cooled to −78° C., and filled with a determined quantity of isobutylene. The reactor was then held at the desired polymerization temperature for a period of 20 minutes and then the organosilicon initiator was injected. In most instances an exothermic reaction ensued with a corresponding rise in pressure resulting in reflux of the monomer with concomitant production of solid polymer. Following injection the reactor was held at the desired reaction temperature for a period of 1 hour. The polymer was dissolved in hexanes and isolated by filtration followed by evaporation of solvent. The results for runs 1-5 are provided in Table 1.

TABLE 1

| | Initiator | Temp. | Conv. | M̅_{w} | |
|---|---|---|---|---|---|
| Run | (mol) | (° C.) | (%) | (g mol⁻¹) | M̅_{w}/ M̅ₙ |
| 1 | TMSCl | −78 | 20.18 | 7.1 × 10⁵ | 8.4 |
| | 4.00 × 10⁻⁵ | | | | |
| 2 | TMSCl | −42 | 19.01 | 5.3 × 10⁵ | 9.6 |
| | 4.00 × 10⁻⁵ | | | | |
| 3 | TMSCl | 0 | 22.82 | 76,730 | 2.1 |
| | 4.00 × 10⁻⁵ | | | | |
| 4 | TMSCl | 25 | 39.08 | 18,870 | 2.7 |
| | 4.00 × 10⁻⁵ | | | | |
| 5 | TMSCl | 25 | 43.87 | 15,600 | 2.6 |
| | 4.00 × 10⁻⁵ | | | | |

Isobutylene Polymerization using Silica Supported Methylaluminoxane 10 wt % in Coniunction with Organic Compounds (Runs 6-7)

A 3 oz pressure reaction bottle was charged with 0.500 g 10 wt % silica supported methylaluminoxane under nitrogen, cooled to −78° C., and filled with a determined quantity of isobutylene. The reactor was then held at the desired polymerization temperature for a period of 20 minutes and then the organic initiator was injected. In most instances an exothermic reaction ensued with a corresponding rise in pressure resulting in reflux of the monomer with concomitant production of solid polymer. The reaction rate depended strongly on the identity of the organic initiator. Following injection the reactor was held at the desired reaction temperature for a period of 1 hour. The polymer was dissolved in hexanes and isolated by filtration followed by evaporation of solvent. The results for runs 6-7 are provided in Table 2.

TABLE 2

| | Initiator | Temp. | Conv. | M̅_{w} | |
|---|---|---|---|---|---|
| Run | (mol) | (° C.) | (%) | (g mol⁻¹) | M̅_{w}/ M̅ₙ |
| 6 | EtBr | 0 | 92.44 | 58,760 | 3.96 |
| | 2.00 × 10⁻⁵ | | | | |
| 7 | EtBr | 26 | 93.5 | 18,990 | 3.82 |
| | 2.00 × 10⁻⁵ | | | | |

### EXAMPLE 2

### Synthesis of Alumina Supported Methylaluminoxane 10 wt %

Neutral aluminum oxide (Acros Organics, 50-200 micron) was dried under dynamic vacuum at 250° C. for 3 hours prior to use. A Schlenk flask was charged with 27.0 g dried aluminum oxide and 3.0 g solid MAO. The flask was then cooled to 0° C. and 150 mL of benzene were cannulated into the flask under nitrogen to produce a slurry. This mixture was then stirred for 16 hours at room temperature after which volatiles were removed under reduced pressure to produce a white solid. This solid was then heated to 175° C. for 2 hours under dynamic vacuum. The solid was then cooled to room temperature and 125 mL of benzene were cannulated into the flask under nitrogen to produce a slurry. The slurry was heated to 70° C. under nitrogen, stirred for 1 hour, filtered, and then dried under reduced pressure at 70° C. for 2 hours.

Isobutylene Polymerization using Alumina Supported Methylaluminoxane 10 wt % in Coniunction with Organic Compounds (Runs 8-9)

A 3 oz pressure reaction bottle was charged with 0.500 g 10 wt % alumina supported methylaluminoxane under nitrogen, cooled to −78° C., and filled with a determined quantity of isobutylene. The reactor was then held at the desired polymerization temperature for a period of 20 minutes and then the organic initiator was injected. In most instances an exothermic reaction ensued with a corresponding rise in pressure resulting in reflux of the monomer with concomitant production of solid polymer. The reaction rate depended strongly on the identity of the organic initiator. Following injection the reactor was held at the desired reaction temperature for a period of 1 hour. The polymer was dissolved in hexanes and isolated by filtration followed by evaporation of solvent. The results for runs 8-9 are provided in Table 3.

TABLE 3

| | Initiator | Temp. | Conv. | M̅_{w} | |
|---|---|---|---|---|---|
| Run | (mol) | (° C.) | (%) | (g mol⁻¹) | M̅_{w}/ M̅ₙ |
| 8 | EtBr | 0 | 93.90 | 54,310 | 3.56 |
| | 2.00 × 10⁻⁵ | | | | |
| 9 | 1,2dClEt | 26 | 99.40 | 44,640 | 2.40 |
| | 2.00 × 10⁻⁵ | | | | |

### EXAMPLE 3

### Synthesis of Boric Acid Supported Methylaluminoxane

Boric acid was dried under dynamic vacuum at 150° C. for 3 hours. A Schlenk flask was loaded with 2.74 g boric acid and 2.57 g solid MAO. The flask was then cooled to 0° C. and 25 mL of benzene were cannulated into the flask under nitrogen to produce a slurry. This mixture was then stirred for 16 hours at room temperature after which volatiles were removed under reduced pressure to produce a white solid. This solid was then heated to 175° C. for 2 hours under dynamic vacuum.

Isobutylene Polymerization using Boric Acid Supported Methylaluminoxane in Conjunction with Organic Compounds (Runs 9-10)

A 3 oz pressure reaction bottle was charged with 0.500 g boric acid supported methylaluminoxane under nitrogen, cooled to −78° C., and filled with a determined quantity of isobutylene. The reactor was then held at the desired polymerization temperature for a period of 20 minutes and then the organic initiator was injected. In most instances an exothermic reaction ensued with a corresponding rise in pressure resulting in reflux of the monomer with concomitant production of solid polymer. The reaction rate depended strongly on the identity of the organic initiator. Following injection the reactor was held at ,he desired reaction temperature for a period of 1 hour. The polymer was dissolved in hexanes and isolated by filtration followed by evaporation of solvent. The results for runs 9-10 are provided in Table 4.

TABLE 4

| | Initiator | Temp. | Conv. | M̅_{w} | |
|---|---|---|---|---|---|
| Run | (mol) | (° C.) | (%) | (g mol⁻¹) | M̅_{w}/ M̅ₙ |
| 9 | EtBr | 0 to 11 | 90.77 | 42,680 | 4.09 |
| | 2.00 × 10⁻⁵ | | | | |
| 10 | EtBr | 20 | 93.12 | 32,060 | 3.73 |
| | 2.00 × 10⁻⁵ | | | | |

### EXAMPLE 4

### Synthesis of MCM-41 Supported Methylaluminoxane 10 wt %

MCM-41 (Aldrich) was dried under dynamic vacuum at 250° C. for 3 hours prior to use. A Schlenk flask was charged with 1.35 g dried MCM-41 and 0.15 g solid MAO. The flask was then cooled to 0° C. and 50 mL of benzene were cannulated into the flask under nitrogen to produce a slurry. This mixture was then stirred for 16 hours at room temperature after which volatiles were removed under reduced pressure to produce a white solid. This solid was then heated to 175° C. for 2 hours under dynamic vacuum. The solid was then cooled to room temperature and 50 mL of benzene were cannulated into the flask under nitrogen to produce a slurry. The slurry was heated to 70° C. under nitrogen, stirred for 1 hour, filtered, and then dried under reduced pressure at 70° C. for 2 hours.

Isobutylene Polymerization using MCM-41 Supported Methylaluminoxane 10 wt % in Conjunction with Organic Compounds (Runs 11-12)

A 3 oz pressure reaction bottle was charged with 0.500 g 10 wt % MCM-41 supported methylaluminoxane under nitrogen, cooled to −78° C., and filled with a determined quantity of isobutylene. The reactor was then held at the desired polymerization temperature for a period of 20 minutes and then the organic initiator was injected. In most instances an exothermic reaction ensued with a corresponding rise in pressure resulting in reflux of the monomer with concomitant production of solid polymer. The reaction rate depended strongly on the identity of the organic initiator. Following injection the reactor was held at the desired reaction temperature for a period of 1 hour. The polymer was dissolved in hexanes and isolated by filtration followed by evaporation of solvent. The results for runs 11-12 are provided in Table 5.

TABLE 5

| | Initiator | Temp. | Conv. | M̅_{w} | |
|---|---|---|---|---|---|
| Run | (mol) | (° C.) | (%) | (g mol⁻¹) | M̅_{w}/ M̅ₙ |
| 11 | EtBr | 0 | 100 | 34,980 | 2.64 |
| | 2.00 × 10⁻⁵ | | | | |
| 12 | EtBr | 25 | 84.24 | 13,430 | 4.5 |
| | 2.00 × 10⁻⁵ | | | | |

### EXAMPLE 5

Isobutylene Polymerization using Methylaluminoxane and Organosilicon Compounds (Runs 13-21)

A 3 oz pressure reaction bottle was charged with 0.093 g methylaluminoxane under nitrogen, cooled to −78° C., and filled with a determined quantity of isobutylene. The reactor was then held at the desired polymerization temperature for a period of 20 minutes and then the organosilicon initiator was injected. In most instances an exothermic reaction ensued with a corresponding rise in pressure resulting in reflux of the monomer with concomitant production of solid polymer. Following injection the reactor was held at the desired reaction temperature for a period of 1 hour. The polymer was dissolved in hexanes and MAO deactivated with 10 wt % HCl in methanol. The hexane layer was extracted and washed twice with deionized water and the polymer was isolated by evaporation of solvent. The results for runs 13-21 are provided in Table 6.

TABLE 6

| | Initiator | Temp. | Conv. | M̅_{w} | |
|---|---|---|---|---|---|
| Run | (mol) | (° C.) | (%) | (g mol⁻¹) | M̅_{w}/ M̅ₙ |
| 13 | TMSCl | −78 | 45.53 | 7 × 10⁶ | 2.6 |
| | 4.00 × 10⁻⁵ | | | | |
| 14 | CSiCl | −78 | 33.45 | 3.1 × 10⁷ | 22 |
| | 2.00 × 10⁻⁵ | | | | |
| 15 | TMSCl | −42 | 19.08 | 2.636 × 10⁵ | 2.0 |
| | 4.00 × 10⁻⁵ | | | | |
| 16 | TMSCl | −42 | 25.44 | 6.070 × 10⁵ | 2.9 |
| | 4.00 × 10⁻⁵ | | | | |
| 17 | CSiCl | −42 | 16.87 | 2.609 × 10⁵ | 1.5 |
| | 2.00 × 10⁻⁵ | | | | |
| 18 | TMSCl | 0 | 4.73 | 116,900 | 1.3 |
| | 4.00 × 10⁻⁵ | | | | |
| 19 | TMSCl | 0 | 16.09 | 93,900 | 2.1 |
| | 4.00 × 10⁻⁵ | | | | |
| 20 | CSiCl | 0 | 2.94 | 71,240 | 1.7 |
| | 1.95 × 10⁻⁵ | | | | |
| 21 | CSiCl | 0 | 1.83 | 92,750 | 1.5 |
| | 1.95 × 10⁻⁵ | | | | |

### EXAMPLE 6

Isobutylene Polymerization using Methylaluminoxane and Halogens (Runs 22-23)

A 3 oz pressure reaction bottle was charged with 0.093 g methylaluminoxane under nitrogen, cooled to −78° C., and filled with a determined quantity of isobutylene. The reactor was then held at the desired polymerization temperature for a period of 20 minutes and then the halogen initiator was injected. In most instances an exothermic reaction ensued with a corresponding rise in pressure resulting in reflux of the monomer with concomitant production of solid polymer. Following injection the reactor was held at the desired reaction temperature for a period of 1 hour. The polymer was dissolved in hexanes and MAO deactivated with 10 wt % HCl in methanol. The hexane layer was extracted and washed twice with deionized water and the polymer was isolated by evaporation of solvent. The results for runs 22-23 are provided in Table 7.

TABLE 7

| | Initiator | Temp. | Conv. | M̅_{w} | |
|---|---|---|---|---|---|
| Run | (mol) | (° C.) | (%) | (g mol⁻¹) | M̅_{w}/ M̅ₙ |
| 22 | I₂ | −78 | 3.22 | 278,000 | 2.2 |
| | 4.00 × 10⁻⁵ | | | | |
| 23 | I₂ | 0 | 6.79 | 53.080 | 1.9 |
| | 4.00 × 10⁻⁵ | | | | |

Isobutylene Polymerization using Methylaluminoxane and Boron Halides (Run 24)

A 3 oz pressure reaction bottle was charged with 0.093 g methylaluminoxane under nitrogen, cooled to −78° C., and filled with a determined quantity of isobutylene. The reactor was then held at the desired polymerization temperature for a period of 20 minutes and then the boron halide initiator was injected. In most instances an exothermic reaction ensued with a corresponding rise in pressure resulting in reflux of the monomer with concomitant production of solid polymer. Following injection the reactor was held at the desired reaction temperature for a period of 1 hour. The polymer was dissolved in hexanes and MAO deactivated with 10 wt % HCl in methanol. The hexane layer was extracted and washed twice with deionized water and the polymer was isolated by evaporation of solvent. The results for run 24 are provided in Table 8.

TABLE 8

| | Initiator | Temp. | Conv. | M̅_{w} | |
|---|---|---|---|---|---|
| Run | (mol) | (° C.) | (%) | (g mol⁻¹) | M̅_{w}/ M̅ₙ |
| 24 | BBr₃ | 0 | 8.97 | 23,470 | 1.6 |
| | 3.00 × 10⁻⁵ | | | | |

Although the present invention has been described in considerable detail with reference to certain embodiments, other embodiments are possible. Therefore, the spirit and scope of the appended claims should not be limited to the description of the embodiments contained herein.

What is claimed is:

1. A process for cationically polymerizing olefin monomers in a reaction mixture, the process comprising the steps of:
contacting olefin monomers and a catalytically effective amount of an initiating composition containing (A) a heterogeneous Lewis acid coinitiator selected from the group consisting of open chain and cyclic aluminoxane compounds of the formulas (I) and (II) 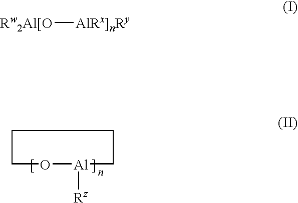
wherein R^{w}, R^{x}, R^{y}, and R^{z} are the same or different and are selected from the group consisting of a C₁-C₁₀ alkyl or a halide, and n is an integer from 2 to 30; wherein the heterogeneous Lewis acid coinitiator is essentially insoluble in the reaction mixture and is either supported on an inert substrate containing reactive functionalities selected from the group consisting of —OH, —SH, and —NH₂, that can chemically bind to the aluminoxane compounds or unsupported by any inert substrate; and (B) an initiator compound selected from the group consisting of (i) organic compounds having the formula (III): 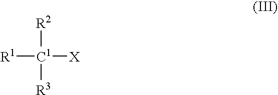
wherein X is selected from the group consisting of halogens, N₃, CN, and CF₃SO₃; and R¹, R², and R³ are selected from the group consisting of a hydrogen atom, halogens, N₃, CN, CF₃SO₃, SiR₃⁴, OSiR₃⁴, C₁-C₁₀ alkyl, C₃-C₁₀ cycloalkyl, C₆-C₁₈ aryl, combinations thereof, and derivatives thereof containing substituents thereof, wherein R⁴ is selected from the group consisting of a hydrogen atom, halogens, N₃, CN, CF₃SO₃, C₁-C₁₀ alkyl, C₃-C₁₀ cycloalkyl, C₆-C₁₈ aryl, combinations thereof, and derivatives thereof containing substituents thereof; and C¹ is a carbon atom; (ii) halogens; (iii) interhalogens; (iv) Brönsted acids, (v) boron halides; and (vi) silicon compounds having the formula (IV): 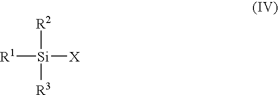
wherein X is selected from the group consisting of halogens, N₃, CN, CF₃SO₃, SiR₃⁴, and OSiR₃⁴; R¹, R², R³ and R⁴ is selected from the group consisting of a hydrogen atom, X, C₁-C₁₀ alkyl, C₃-C₁₀ cycloalkyl, C₆-C₁₈ aryl, combinations thereof and derivatives thereof containing substituents thereof; with the proviso that where the Lewis acid coinitiator is unsupported, then the initiator is selected from the initiator compounds other than the organic compounds of formula (III), under cationic polymerization reaction conditions.

2. The process of claim 1, wherein the olefin monomers are selected from the group consisting of propylene, 1-butene, isobutylene, 2-methyl-1-butene, butadiene, isoprene, piperylene, 2,3-dimethylbutadiene, 2,4-dimethyl-1,3-pentadiene, cyclopentadiene, methylcyclopentadiene, limonene, myrcene, 1,3-cyclohexadiene, α- and β-pinene, α-methyl styrene, styrene, ρ-methyl styrene, vinyl-toluene, divinylbenzene, indene, coumarone, methyl vinyl ether, ethyl vinyl ether, and isobutyl vinyl ether.

3. The process of claim 1, wherein the heterogeneous Lewis acid coinitiator is an aluminoxane compound chemically attached to an inert inorganic support, which support is unable to induce polymerization by itself, and wherein the inert inorganic support is selected from the group consisting of silica, alumina, titania, magnesia, zirconia, zinc oxide, iron oxides, barium oxide, chromium oxides, manganese dioxide, silica-alumina, silica-titania, silica-magnesia, silica-alumina-zirconia, silica-alumina-thoria, crystalline aluminosilicates, natural zeolites; mesoporous molecular sieves, open lattice clays, metal hydroxides, boric acid, hydrated magnesium chloride, and metal oxide gels and gel oxides.

4. The process of claim 1, wherein the heterogeneous Lewis acid coinitiator is an aluminoxane compound chemically attached to an inert organic support, which support is unable to induce polymerization by itself, and wherein the inert organic support is selected from the group consisting of polysaccharides, starches, cellulosic polymers, phenolic resins, phenol-aldehyde, amino resins, urea-aldehyde, ion-exchange resins, amino-, hydroxyl-, and thiol-functionalized divinylbenzene crosslinked polystyrenes, poly(allylamine), poly(4-vinyl phenol), poly(vinyl alcohol), and polyethyleneimine.

5. The process according to claim 1, wherein the cationic polymerization of the olefin monomer occurs in at least one polymerization step phase selected from the group consisting of bulk, solution, suspension, gas phase, and combinations thereof.

6. The process according to claim 1, wherein the cationic polymerization of the olefin monomer occurs at a temperature equal to or higher than that of an initiator system comprising a chlorinated solvent and produces a higher molecular weight polymer than does the polymerization of an olefin monomer in a chlorinated solvent.

7 The process according to claim 1, wherein the cationic polymerization of the olefin monomer occurs in the absence of any chlorinated solvent.

8. An initiator system for use with a reaction mixture in the cationic polymerization of olefins, the initiator system comprising:
(a) a hetergeneous Lewis acid coinitiator selected from the group consisting of open chain and cyclic aluminoxane compounds of the formula (I) and (II) 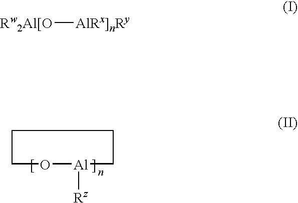
wherein R^{w}, R^{x}, R^{y}, and R^{z} are the same or different and are C₁-C₁₀ alkyls or halides, and n is an integer from 2 to 30, and wherein the heterogeneous Lewis acid coinitiator is essentially insoluble in the reaction mixture and is either supported on a inert substrate containing reactive functionalities selected from the group consisting of —OH, —SH, and —NH₂, that can chemically bind to the aluminoxane compounds or unsupported by any inert substrate; and
(b) an initiator selected from the group consisting of (i) organic compounds having the formula (III): 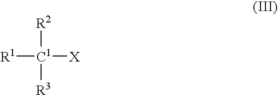
wherein X is selected from the group consisting of halogens, N₃, CN, and CF₃SO₃; and R¹, R², and R³ is selected from the group consisting of a hydrogen atom, halogens, N₃, CN, CF₃SO₃, SiR₃⁴, OSiR₃⁴, C₁-C₁₀ alkyl, C₃-C₁₀ cycloalkyl, C₆-C₁₈ aryl, combinations thereof, and derivatives thereof containing substituents thereof; and R⁴ is selected from the group consisting of a hydrogen atom, halogens, N₃, CN, CF₃SO₃, C₁-C₁₀ alkyl, C₃-C₁₀ cycloalkyl, C₆-C₁₈ aryl, combinations thereof, and derivatives thereof containing substituents thereof; and C¹ is a carbon atom; (ii) halogens; (iii) interhalogens; (iv) Brönsted acids, (v) boron halides; and (vi) silicon compounds having the formula (IV): 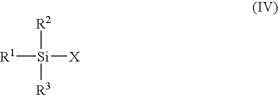
wherein X is selected from the group consisting of halogens, N₃, CN, CF₃SO₃, SiR₃⁴, and OSiR₃⁴; R¹, R², R³ and R⁴ is selected from the group consisting of a hydrogen atom, X, C₁-C₁₀ alkyl, C₃-C₁₀ cycloalkyl, C₆-C₁₈ aryl, combinations thereof and derivatives thereof containing substituents thereof;
with the proviso that where the Lewis acid coinitiator is unsupported, then the initiator is selected from the compounds other than the (i) organic compounds of formula (III).

9. The initiator system of claim 8, wherein the heterogeneous Lewis acid coinitiator is an aluminoxane compound chemically attached to an inert inorganic support, which support is unable to induce polymerization by itself, and wherein the inert inorganic support is selected from the group consisting of silica, alumina, titania, magnesia, zirconia, zinc oxide, iron oxides, barium oxide, chromium oxides, manganese dioxide, silica-alumina, silica-titania, silica-magnesia, silica-alumina-zirconia, silica-alumina-thoria, crystalline aluminosilicates, natural zeolites; mesoporous molecular sieves, open lattice clays, metal hydroxides, boric acid, hydrated magnesium chloride, and metal oxide gels and gel oxides.

10. The initiator system of claim 8, wherein the heterogeneous Lewis acid coinitiator is an aluminoxane compound chemically attached to an inert organic support, which support is unable to induce polymerization by itself, and wherein the inert organic support is selected from the group consisting of polysaccharides, starches, cellulosic polymers, phenolic resins, phenol-aldehyde, amino resins, urea-aldehyde, ion-exchange resins, amino-, hydroxyl-, and thiol-functionalized divinylbenzene crosslinked polystyrenes, poly(allylamine), poly(4-vinyl phenol), poly(vinyl alcohol), and polyethyleneimine.
